(19) United States
(12) Patent Application Publication
(10) Pub. No.: US 2008/0087475 A1
(43) Pub. Date: Apr. 17, 2008

(54) Weighing scale

(76) Inventor: Steven Petrucelli, Cranbury, NJ (US)

Correspondence Address: Howard IP Law Group, P.O. Box 226, Fort Washington, PA, 19034, US

(21) Appl. No.: 11/580,539

(22) Filed: Oct. 13, 2006

(51) Int. Cl. G01G 7/00

(52) U.S. Cl. 177/201

(57) ABSTRACT

A system for determining and displaying a weight includes a support from which an object may hang; a load cell physically coupled to the support for providing an electrical signal indicative of a weight of an object on the support; a wireless transmitter for receiving a load cell output signal from the load cell indicative of a weight on the object support and for wirelessly transmitting a signal representative of the weight; and a receiving unit having a wireless receiver for receiving the wirelessly transmitted signal and a display for displaying a weight value received by the wireless receiver.

### FIELD OF THE INVENTION

This application relates generally to weighing scales, and particularly to weighing scales for weighing a hanging object.

### BACKGROUND OF THE INVENTION

Scales attached to hoists are known apparatuses for weighing numerous artifacts including animal carcasses and game fish. For hunters the weighing of carcasses is often a requirement under the local hunting laws and regulations. However, weighing of large carcasses is often a laborious undertaking and one where hunters typically rely on butchers to accomplish the task. When hunters do not witness the actual weighing they must depend on second hand and often-untrustworthy information. For hunters in the field there exists no convenient way to weigh a large and heavy carcass. Most apparatuses require the individual taking a weight measurement to climb a ladder to read the scale. Hunters without the benefit of ladders stand on tailgates to read generally small numbers on a slide or dial game weight scale. These efforts to determine the weight are dangerous and unreliable. In addition, liquid crystal display readouts, while usually easier to read than a mechanical indicator, do not function adequately at the low temperatures associated with hunting during the fall and winter months in northern climates.

In sport fishing, knowledge of the weight of the catch is critical. However, weighing large fish requires supporting the fish on a hook high above a dock or other surface, requiring the fisherman to climb a ladder to see the readout of a mechanical scale.

It is therefore desired to provide a weighing scale for large hanging objects which avoids difficulties in observing the readout.

### SUMMARY OF THE INVENTION

A system for determining and displaying a weight may include a support from which an object may hang; a load cell physically coupled to the support for providing an electrical signal indicative of a weight of an object on the support; a wireless transmitter for receiving a load cell output signal from the load cell indicative of a weight on the object support and for wirelessly transmitting a signal representative of the weight; and a receiving unit including a wireless receiver for receiving the wirelessly transmitted signal and a display for displaying a weight value received by the wireless receiver.

An apparatus for providing a signal indicative of a weight of an object includes a block having at least one pulley mounted thereon to rotate; an object support; and a load cell physically coupled between the block and the object support.

A method for providing a weight of an object supported on an object support for supporting a hanging object includes the steps of: receiving from a load cell coupled between the object support and a block having at least one pulley mounted thereon to rotate an output signal representing a detected weight on the object support; wirelessly transmitting a signal representing the detected weight; receiving the wirelessly transmitted signal at a remote unit; and displaying the detected weight at the remote unit.

A method of weighing an object includes the steps of: causing the object to be supported in a hanging orientation by an object support; causing a load cell physically coupled to the object support to generate an output signal indicative of the weight of a load on the object support, and a signal indicative of the weight to be wirelessly transmitted; and reviewing a weight displayed on a remote unit that has received the wirelessly transmitted signal.

### BRIEF DESCRIPTION OF THE DRAWINGS

Understanding of the present invention will be facilitated by considering the following detailed description of the preferred embodiments of the present invention taken in conjunction with the accompanying drawings, in which like numerals refer to like parts, and:

FIG. 1 illustrates a system for detecting and displaying the weight of an object in accordance with an embodiment of the invention, with a portion thereof deployed on an exemplary support structure.

FIG. 2 is a partial exploded view of mechanical components of a base unit of the system of FIG. 1.

FIG. 2A is a cross-section of the load cell shown in FIG. 2.

FIG. 3 is a block diagram of a base unit of the system of FIG. 1.

FIG. 4 is a block diagram of a display unit of the system of FIG. 1.

FIG. 5 is a perspective view of a display unit of the system of FIG. 1.

FIG. 6 is a process flow diagram of a method of detecting and displaying a weight of a hanging object in accordance with an embodiment of the invention.

### DETAILED DESCRIPTION OF EMBODIMENTS OF THE INVENTION

It is to be understood that the figures and descriptions of the present invention have been simplified to illustrate elements that are relevant for a clear understanding of the present invention, while eliminating, for the purpose of clarity, many other elements found in typical weighing systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

Further, it should be understood that the several views of the housings, displays and general configurations shown in the figures include many decorative or ornamental features, aspects of which the particulars may be changed while maintaining the device's utility and without departing from the scope and spirit of the present invention.

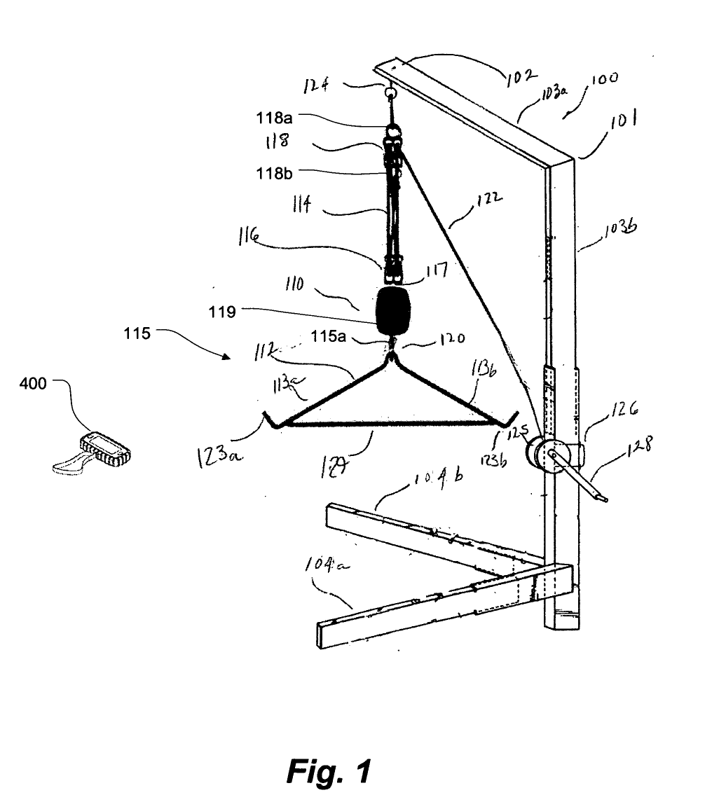

Referring to FIG. 1, there is shown, for non-limiting purposes of explanation, a system 100 for detecting and displaying a weight of an object in accordance with an embodiment of the invention. In operation, the components for generating a signal representing a weight hang from an overhead support. In this exemplary illustration, those components are supported on and hang downward from horizontal support member 103b of stand 101. Stand 101 also includes a pair of generally horizontal support bases, 104a, 104b that attach to a vertical member 103b. Horizontal support member 103a generally forms a right angle with vertical member 103b.

System 100 includes a load cell within housing 119 and therefore not shown in FIG. 1, an object support 115 physically coupled to the load cell, and traveling block 116, having at least one pulley thereon; traveling block 116 is physically coupled to the load cell and generally opposite to object support 115. “Block” as used here means an apparatus having a wheel with a groove mounted to rotate, the apparatus being open to permit a rope or cord to be looped around the wheel. Block 116 in the illustrated embodiment is a traveling block of block and tackle 114. In the illustrated embodiment, block and tackle 114 includes traveling block 116, standing block 118 and cable 122. In the illustrated embodiment, each of traveling block 116 and standing block 118 has two pulleys. Standing block 118 has rings 118a, 118b on the top and bottom, respectively, thereof. A first end of cable 122 is secured to bottom ring 118b of standing block 118, and leads, in succession, around a first pulley of traveling block 116, a first pulley of standing block 118, a second pulley of traveling block 116, and a second pulley of standing block 118. In the illustrated embodiment, a second end of cable 122 is on pulley 125 of winch 126. Winch 126 is secured relative to the vertical support member 103b. Standing block 118 is mounted by its upper ring 118a, such as through a simple hook and ring device 124 at a fixed location 102 on the support member 103a. Winch 126 may be manually operated through a crank 128 to hoist an object, such as a game carcass or fish, above the ground for weighing. A motor may be provided to operate winch 126. Alternatively, the second end of cable 122 may be free so that a user may simply pull on the second end of cable 122 to raise an object supported on object support 115.

Object support 115 may include hook 115a and may include hanger 112 supported on hook 115a. Object support 115 may be rotatably supported with respect to housing 119 and the load cell contained therein, and may be able to rotate freely 360 degrees with respect to housing 119 and the load cell, thereby effectively being self-positioning.

Hanger 112, in the embodiment of FIG. 1, includes a pair of lateral bars 113a and 113b extending in opposed directions from an eye 120, which is positioned on hook 115a, and terminating in outer distal ends. At the outer distal ends are exterior hooks 123a, 123b that extend from the lateral bars 113a, and 113b for engaging an object to be hung and weighed. A cross bar 129 extends between the lateral bars 113a, 113b to stabilize the lateral bars relative to one another and to permit further securing of objects to be hung.

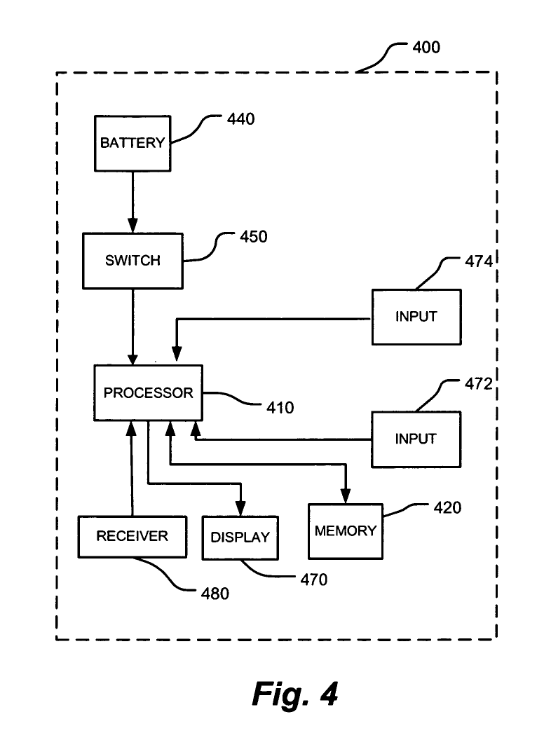

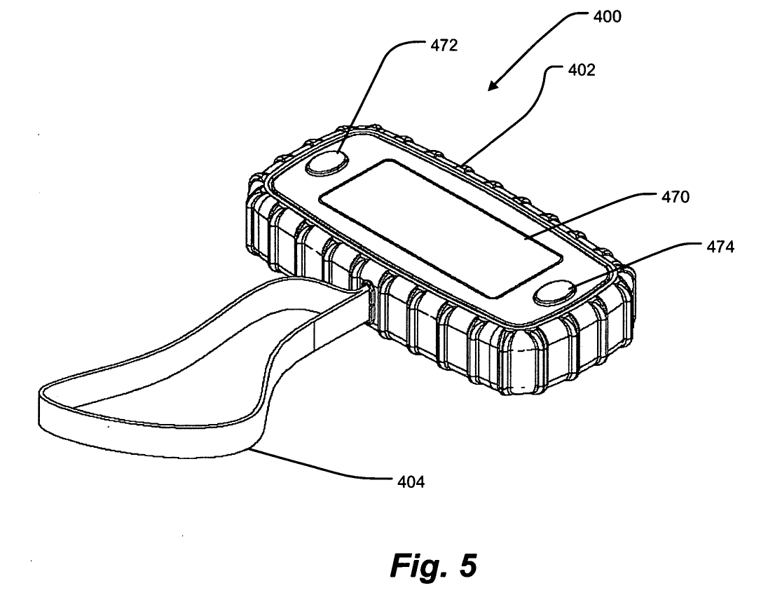

Display module 400 shown in FIG. 1 includes a wireless receiver (not shown) and display 161. Display module 400 is further explained below with reference to FIGS. 4 and 5.

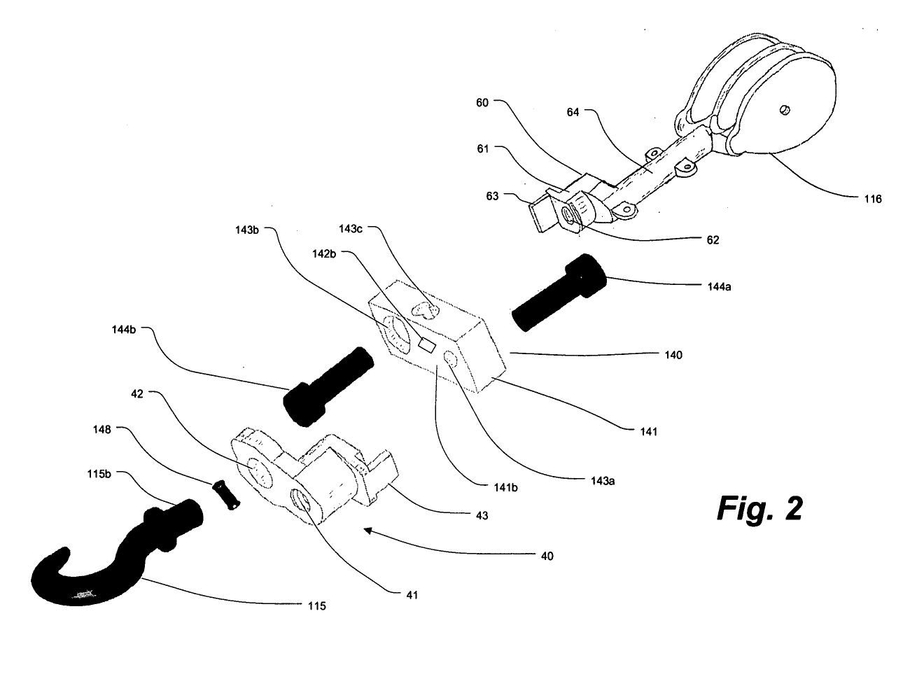

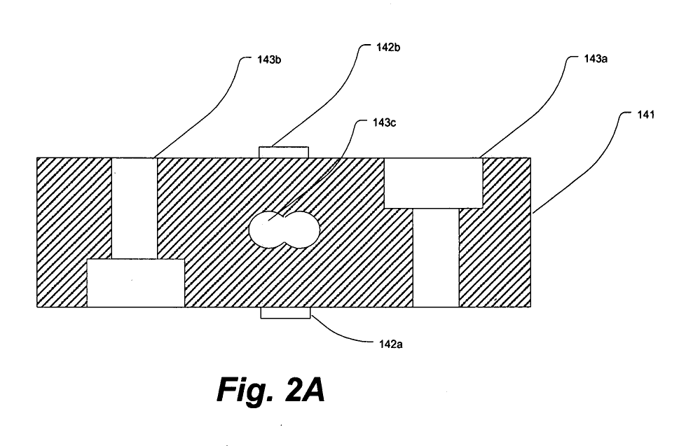

Referring now to FIG. 2, an exploded view of mechanical portions of base unit of weighing scale 100 is shown. For ease of viewing, housing 119 is not shown. Load cell 140 is shown. Load cell 140 may be any device that provides an output electrical signal dependent on forces applied to the device. In the illustrated embodiment, load cell 140 includes a solid body 141, lower strain gauge 142b disposed on lower surface 141b of body 141, an upper strain gauge (not shown) disposed substantially opposite to lower strain gauge 142b on upper surface of body 141, and associated circuits (not shown) to provide an output signal dependent on strain detected by the strain gauges, which detected strain is related to a load on load cell 140. Body 141 may be of a suitable material, such as a metal, which may be aluminum. The strain gauges may be foil gauges.

In the embodiment shown in FIG. 2, body 141 is physically coupled to traveling block 116 and to object support 50. Body 141 is generally rectangular in shape. Near opposing ends of body 141 are cylindrical vertical through bores 143a, 143b. Bore 143a has a first portion of relatively large diameter near an upper surface of body 141, and a second portion of relatively small diameter near lower surface 141 b. Relatively small diameter second portion of bore 143a may be threaded. Bore 143b similarly has a first portion of relatively large diameter near lower surface 141a, and a second portion of relatively small diameter near the upper surface of body 141. Bolt 144a is received in and extends beyond bore 143a. The head of bolt 144a is received in the relatively large diameter first portion of bore 143a. Bolt 144a may be threaded to mate with the thread in relatively small diameter second portion of bore 143a. Similarly, bolt 144b is fastened in and extends beyond bore 143b.

Bolt 144a is coupled physically to the object hanger 115. Bolt 144b is coupled physically to traveling block 116.

The portion of bolt 144a extending beyond bore 143a is connected to hanger coupling 40. Bolt 144a is received in bore 41 in hanger coupling 40. Bore 41 may be threaded to mate with bolt 144a. Hanger coupling 40 also includes a bore 42 adapted to support pin 148. Object support 115 has a bore 115b therein through which pin 148 is mounted, and object support 115 may rotate about pin 148. Hanger coupling 40 also has a projecting flange 43 with a planar surface to mate with an end surface of body 141.

The portion of bolt 144b extending beyond bore 143b is connected to block coupling 60. Block coupling 60 includes a solid body 61 having threaded bore 62 therein which mates with threaded portion of bolt 144b. Block coupling 60 also has a projecting flange 63 with a planar surface to mate with an end surface of body 141. Block coupling 60 includes rod 64 which connects body 61 to traveling block 116.

It will be appreciated by those of skill in the art that the above-captioned arrangement serves to emulate an “S” type load cell. It will be appreciated that other types of load cells may be employed. Typical weight capacities may range from about 1 pound to about 1500 lbs.

The load cell 140 outputs a current or voltage related to a strain on body 141 detected by strain gauges arranged on surfaces of body 141.

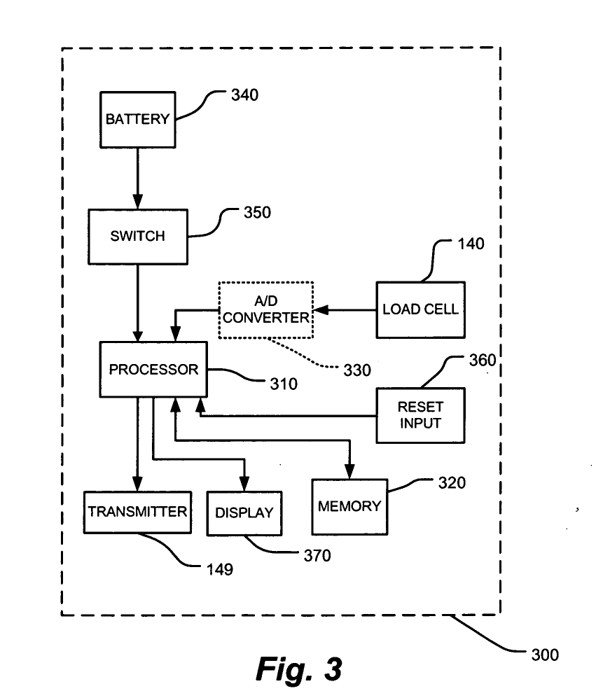

Referring now also to FIG. 3, there is shown a block diagrammatic view of an arrangement 300 suitable for use within base unit 119 of FIGS. 1 and 2. Arrangement 300 generally includes a processor 310, memory 320, optional analog to digital converter 330, battery 340, switch 350, reset input 360, display 370 and load cell 140.

“Processor”, as used herein, generally refers to a circuit arrangement that may be contained on one or more silicon chips, and/or integrated circuit (IC) boards, and that contains a Central Processing Unit (CPU). The CPU may generally include an arithmetic logic unit (ALU), which performs arithmetic and logical operations, and a control unit, which extracts instructions from memory and decodes and executes them, calling on the ALU when necessary.

Processor 310 may take the form of a microprocessor, and may be a low power CMOS processor with an embedded analog to digital converter, by way of non-limiting example only. The present invention is operable with computer storage products or computer readable media that contain program code for performing the various computer-implemented operations. The computer-readable medium is any data storage device that can store data which can thereafter be read by a computer system such as a microprocessor. The media and program code may be those specially designed and constructed for the purposes of the present invention, or they may be of the kind well known to those of ordinary skill in the computer software arts. Examples of computer-readable media include, but are not limited to magnetic media such as hard disks, floppy disks, and magnetic tape; optical media such as CD-ROM disks; magneto-optical media; and specially configured hardware devices such as application-specific integrated circuits (ASICs), programmable logic devices (PLDs), and ROM and RAM devices. Examples of program code include both machine code, as produced, for example, by a compiler, or files containing higher-level code that may be executed using an interpreter.

Processor 310 may include multiple inputs and outputs. In the exemplary configuration illustrated in FIG. 3, processor 310 has an input coupled to switch 350. A source of current, such as battery 340, is coupled to processor 310 through switch 310. Outputs of processor 310 may be coupled to transmitter 149 and display 350. Processor 310 may also be coupled to memory 320 to allow it to access its data contents. Processor 310 may have an input coupled to load cell 140 optionally via analog-to-digital converter (A/D) 330. For example, where load cell 140 provides an analog output signal indicative of a load sensed on object support 115, A/D converter 330 may communicate a digital signal indicative of the analog signal output from load cell 140 to processor 310. Where load cell 140 provides a digital signal directly, A/D converter 330 may optionally be omitted. Also, where processor 310 is adapted to receive analog signals output from load cell 140 directly, A/D converter 330 may optionally be omitted. A/D converter 330 may be selected based upon size limitations of body 119, an expected output from load cell 140, accepted input for processor 310 and available power sources.

Memory 320 may be internal or external to processor 310. As used herein, “memory” refers generally to one or more devices capable of storing data, such as in the form of chips, tapes or disks. Memory may take the form of one or more random-access memory (RAM), read-only memory (ROM), programmable read-only memory (PROM), erasable programmable read-only memory (EPROM), or electrically erasable programmable read-only memory (EEPROM) chips, by way of further non-limiting example only. Memory 320 may store information, or may be programmed to store information, e.g., a look up table mapping received digital signal values to weight values. Memory 320 may store a weight reading, for example.

Switch 350 may be in an open position when weighing scale 100 is not in use. Processor 310 may be placed in a powered on state by a user moving switch 350 to a closed position. Alternatively, by way of example, closing of switch 350 may activate a circuit which provides a wake signal to processor 310. Reset input 360 may be a button or switch that provides a signal to processor 310 to perform start up functions and to clear memory 320 of any stored recent weight readings. Display 370 may be an indicator as to whether processor 310 is in an awake or asleep mode, and may be an illuminated display, for example.

Transmitter 150 may be any suitable wireless transmitter, and may be a radiofrequency transmitter. By way of example, any one of a number of commercially available low power compact transceivers for transmitting at frequencies such as 433 MHz may be employed.

FIG. 4 is a block diagram of a display module 400. Display module 400 includes processor 410, which may be similar to processor 310. Display module 400 includes a source of current, such as battery 440, which may be coupled to an input of processor 410 through switch 450. Display module 400 further includes display 470. Display 470 is preferably an alphanumeric display, and may be a liquid crystal display (LCD). An output of processor 410 is electrically coupled to one or more inputs of display 470. Display module 400 further includes receiver 480, which is adapted to receive wireless transmissions from wireless transmitter 150. Receiver 480 provides data received wirelessly from wireless transmitter to processor 410.

FIG. 5 is a perspective view of an exemplary display module 400. Display module 400 has housing 402, which may be of ABS, by way of example, and features display 470 and two user inputs 472, 474, which may in the form of buttons as shown. Housing 402 has attached thereto flexible strap 404.

A variety of wireless transmitting techniques may be employed, including, by way of non-limiting example, a Wi-Fi enabled computer and/or handset that uses radio technologies based on, for example, the IEEE 802.11 standard to send and receive data anywhere within the range of a base station transceiver or a Bluetooth® wireless technology transceiver. Remote unit 400 may, for example, take the form of a handheld display device or may be a multi-function device such as a personal digital assistant (PDA), a handheld mobile phone. The application software on the remote unit 400, may by way of non-limiting example employ Physical Markup Language (PML). PML, a markup language based on XML for communicating a description of physical environments and the objects within them, their relationships to the user of the product associated with as in this instance a transmitter of weight information, and the space or location where the unit 110 is located.

A system in accordance with an embodiment of the invention may include more than one display unit incorporating a wireless receiver, a processor and a display. For non-limiting purposes of explanation, in one embodiment the wireless transmitter 150 communicates with the receiver and associated display unit up to about sixty (60′) feet from the point of measurement.

A program stored in memory 180 and running on processor 140 may permit a user to enter a name or identifying information associated with a user, a type of object weighed (such as a type of game or fish), and such information may be stored in memory 180. Memory 180 may also store other information related to measurements, including, by way of example, time and date information.

Those skilled in the art of computer programming will appreciate that the invention may be implemented in a system of computer units or processors communicatively coupled to one another over a network, such as a wide area network.

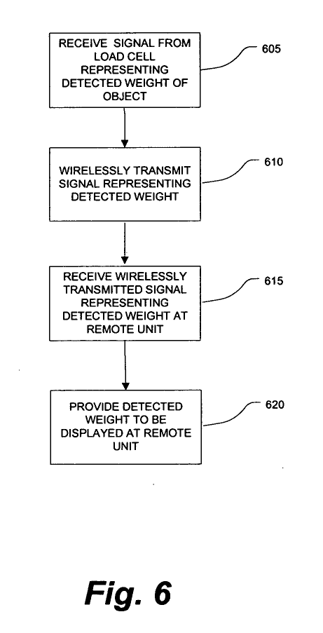

FIG. 6 is a process flow diagram illustrating an exemplary method performed by a system 100 for detecting and displaying a weight of a hanging object. The steps indicated by the initial blocks in the diagram of FIG. 6 are performed at the processor 310. In a step indicated at block 605, processor 310 receives a weight signal from load cell 140. Processor 310 then causes a weight value to be transmitted wirelessly, as indicated by block 610. The wirelessly transmitted signal is received by wireless receiver 480, which then transmits a signal to processor 410, so that processor 410 receives the signal containing the detected weight, as indicated by block 615. Processor 410 may then send a signal to display 470 causing the received weight value to be displayed, as indicated by block 620.

A method for weighing an object, which may be, by way of example, a carcass or a caught fish, may include the steps of: hanging stationary block 118 from a support such as arm 102, engaging a load on object support 115, and using rope 122 to bring traveling block 116 closer to stationary block 118 until object support 115 is sufficiently high that the object is supported in a hanging orientation on object support 115. The user may then cause load cell 140, which is coupled between object support 115 and traveling block 116, to provide an output signal representing a weight on object support 115, which output signal may be provided to processor 310. The user may engage switch 350 to wake processor 310 in order to cause a signal from load cell 140 to be received by processor 310. Processor 310 causes a wireless signal representing the detected weight to be transmitted. The user may activate remote unit 400, such as by closing switch 450. The user may maintain remote unit 400 at a location that is more convenient for viewing or for maintaining the temperature of unit 400 than the location of housing 119. Such more convenient location may be, by way of example, in the user's hand, in or on a vehicle, or on a bench or table. The more convenient location for maintaining the temperature may be a pocket of the clothing of the user, or the interior of a heated vehicle. Remote unit 400 may receive the wireless signal and display the weight. The user may review the displayed weight.

A variety of wireless transmitting techniques may be employed, including, by way of non-limiting example, a Wi-Fi enabled computer and/or handset that uses radio technologies based on, for example, the IEEE 802.11 standard to send and receive data anywhere within the range of a base station transceiver or a Bluetooth® wireless technology transceiver. Remote unit 400 may, for example, take the form of a handheld display device or may be a multi-function device such as a personal digital assistant (PDA), a handheld mobile phone. The application software on the remote unit 400, may by way of non-limiting example employ Physical Markup Language (PML). PML, a markup language based on XML for communicating a description of physical environments and the objects within them, their relationships to the user of the product associated with as in this instance a transmitter of weight information, and the space or location where the unit 110 is located.

A system in accordance with the invention may include more than one receiver. For non-limiting purposes of explanation, in one embodiment the transmitter 150 communicates with the receiver and associated display unit up to about sixty (60′) feet from the point of measurement.

Remote unit 400 may be adapted to provide audible output, such as through one or more speakers providing output of signals from a library of sound files. Such output may be as an alternative to or in addition to a display.

While the present invention has been described with reference to the illustrative embodiments, this description is not intended to be construed in a limiting sense. Various modifications of the illustrative embodiments, as well as other embodiments of the invention, will be apparent to those skilled in the art on reference to this description. It is expressly intended that all combinations of those elements that perform substantially the same function in substantially the same way to achieve the same results are within the scope of the invention. Substitutions of elements from one described embodiment to another are also fully intended and contemplated.

What is claimed is:

1. A system for determining and displaying a weight, comprising:
a support from which an object may hang;
a load cell physically coupled to said support for providing an electrical signal indicative of a weight of an object on said support; a wireless transmitter for receiving a load cell output signal from said load cell indicative of a weight on said object support and for wirelessly transmitting a signal representative of said weight; and
a receiving unit comprising a wireless receiver for receiving said wirelessly transmitted signal and a display for displaying a weight value received by said wireless receiver.

2. The system of claim 1, further comprising a traveling block having at least one pulley mounted thereon to rotate, said traveling block being physically coupled to said load cell.

3. The system of claim 2, wherein said load cell comprises a body having a first strain gauge on an upper surface thereof, and a second strain gauge on a lower surface thereof, said body being coupled at respective opposing ends to said traveling block and said object support.

4. The system of claim 2, further comprising a stationary block having at least one pulley mounted thereon to rotate.

5. The system of claim 1, wherein said object support comprises a hook.

6. The system of claim 1, wherein said object support comprises a hanger.

7. The system of claim 1, wherein said display comprises a liquid crystal display.

8. An apparatus for providing a signal indicative of a weight of an object, comprising:
a block having at least one pulley mounted thereon to rotate;
an object support; and
a load cell physically coupled between said block and said object support.

9. The apparatus of claim 8, further comprising a wireless transmitter for receiving a load cell output signal from said load cell indicative of a weight on said object support and for wirelessly transmitting a signal representative of said weight.

10. The apparatus of claim 8, wherein said object support comprises a hook.

11. The apparatus of claim 8, wherein said object support comprises a hanger.

12. The apparatus of claim 8, wherein said object support is coupled to said load cell so as be capable of rotating relative to said load cell.

13. The apparatus of claim 8, wherein said load cell comprises a body having a first strain gauge on an upper surface thereof, and a second strain gauge on a lower surface thereof, said body being coupled near respective opposing ends to said block and said object support.

14. A method for providing a weight of an object supported on an object support for supporting a hanging object, comprising the steps of:
receiving from a load cell coupled between the object support and a block having at least one pulley mounted thereon to rotate an output signal representing a detected weight on the object support;
wirelessly transmitting a signal representing the detected weight;
receiving the wirelessly transmitted signal at a remote unit; and
displaying the detected weight at the remote unit.

15. The method of claim 14, wherein said step of displaying comprises displaying on a liquid crystal display.

16. A method of weighing an object, comprising the steps of:
causing the object to be supported in a hanging orientation by an object support;
causing a load cell physically coupled to said object support to generate an output signal indicative of the weight of a load on the object support, and a signal indicative of the weight to be wirelessly transmitted; and
reviewing a weight displayed on a remote unit that has received the wirelessly transmitted signal.

17. The method of claim 16, further comprising the step of maintaining a temperature of the remote unit above the ambient temperature.

18. The method of claim 16, wherein said step of maintaining a temperature of the remote unit comprises maintaining the remote unit in a pocket of clothing of the user.

19. The method of claim 16, wherein said step of causing the object to be supported in a hanging position comprises employing a block and tackle arrangement including a traveling block coupled to the load cell and a stationary block engaged by a cable to the traveling block to lift the object to a hanging position.
